(19) United States
(12) Patent Application Publication
(10) Pub. No.: US 2013/0295995 A1
(43) Pub. Date: Nov. 7, 2013

(54) SYSTEM FOR DOCKING A MOBILE TELEPHONE TO A PERSONAL ELECTRONIC DEVICE

(71) Applicant: Jerry FIELDING, JR., Brighton, MI (US)

(72) Inventor: Jerry FIELDING, JR., Brighton, MI (US)

(21) Appl. No.: 13/875,456

(22) Filed: May 2, 2013

Related U.S. Application Data
(60) Provisional application No. 61/642,717, filed on May 4, 2012.

(51) Int. Cl. H04M 1/02

(52) U.S. Cl. CPC H04M 1/0254
USPC 455/557

(57) ABSTRACT

A system for docking a mobile telephone to a personal electronic device includes a mobile telephone and a personal electronic device. The mobile telephone may include a first front face defining a first display with a first display area. The personal electronic device may include a second front face defining a second display with a second display area. The second front face may define an opening for receiving the mobile telephone. The mobile telephone and the personal electronic device may cooperate to define a resulting device having a resulting display having a resulting display area equal to the sum of the first and second display areas when the mobile telephone is electronically coupled to the personal electronic device.

### CROSS-REFERENCE TO RELATED APPLICATIONS

This application claims priority to U.S. Provisional Patent Application No. 61/642,717 filed 4 May 2012, which application is herein expressly incorporated by reference.

### FIELD

The present teachings generally concern mobile telephones. More particularly, the present teachings concern a system for docking a mobile telephone to a personal electronic device.

### BACKGROUND

Mobile telephones are used increasingly used for various tasks and purposes beyond conventional telephones. For example, mobile telephones conventionally incorporate technology previously found on a personal digital assistant or on a computer. Such technology allows the user to send and receive email communications, edit and save documents, store and play music files, store and display picture files, maintain calendar dates, access the internet, among other task. Mobile telephones with such advanced capabilities are often referred to as “smart phones”.

Mobile telephones, particularly those with advanced electronic capabilities, require frequent charging. It is often desirable to exchange data between a mobile telephone and other electronic devices, such as laptop computers and tablet computers. One limitation inherent to mobile telephones relates to the limited size of the display image.

While known mobile telephones have proven to be satisfactory for their intended uses, an ongoing need for improvement remains in the pertinent art.

### SUMMARY

According to one particular application, the present teachings provide a system for docking a mobile telephone to a personal electronic device. The system includes a mobile telephone and a personal electronic device. The mobile telephone may include a first front face defining a first display with a first display area. The personal electronic device may include a second front face defining a second display with a second display area. The second front face may define an opening for receiving the mobile telephone. The mobile telephone and the personal electronic device may cooperate to define a resulting device having a resulting display having a resulting display area equal to the sum of the first and second display areas when the mobile telephone is electronically coupled to the personal electronic device.

Further areas of applicability of the present teachings will become apparent from the detailed description provided hereinafter. It should be understood that the detailed description and specific examples, while indicating the particular embodiments of the present teachings, are intended for purposes of illustration only and are not intended to limit the scope of the invention.

### DRAWINGS

The present teachings will become more fully understood from the detailed description, the appended claims and the following drawings.

FIG. 1 is a perspective view of a system including a mobile telephone docket to a personal electronic device in accordance with the present teachings, the personal electronic device being a computer tablet.

FIG. 2 is another perspective view of a system including a mobile telephone docket to a personal electronic device in accordance with the present teachings, the personal electronic device being a computer tablet.

FIG. 3 is another perspective view of a system including a mobile telephone docket to a personal electronic device in accordance with the present teachings, the personal electronic device being a computer tablet.

FIG. 4 is another perspective view of a system including a mobile telephone docket to a personal electronic device in accordance with the present teachings, the personal electronic device being a computer tablet.

FIG. 5 is another perspective view of a system including a mobile telephone docket to a personal electronic device in accordance with the present teachings, the personal electronic device being a computer tablet.

FIG. 6 is another perspective view of a system including a mobile telephone docket to a personal electronic device in accordance with the present teachings, the personal electronic device being a laptop computer.

FIG. 7 is another perspective view of a system including a mobile telephone docket to a personal electronic device in accordance with the present teachings, the personal electronic device being a laptop computer.

FIG. 8 is another perspective view of a system including a mobile telephone docket to a personal electronic device in accordance with the present teachings, the personal electronic device being a laptop computer.

FIG. 9 is another perspective view of a system including a mobile telephone docket to a personal electronic device in accordance with the present teachings, the personal electronic device being a laptop computer.

FIG. 10 is another perspective view of a system including a mobile telephone docket to a personal electronic device in accordance with the present teachings, the personal electronic device being a television.

FIG. 11 is another perspective view of a system including a mobile telephone docket to a personal electronic device in accordance with the present teachings, the personal electronic device being a television.

FIG. 12 is another perspective view of a system including a mobile telephone docket to a personal electronic device in accordance with the present teachings, the personal electronic device being a television.

FIG. 13 is another perspective view of a system including a mobile telephone docket to a personal electronic device in accordance with the present teachings, the personal electronic device being a television.

### DESCRIPTION OF VARIOUS ASPECTS

The following description is merely exemplary in nature and is not intended to limit the present disclosure, application, or uses. It should be understood that throughout the drawings, corresponding reference numerals indicate like or corresponding parts and features. The description and any specific examples, while indicating embodiments of the present disclosure, are intended for purposes of illustration only and are not intended to limit the scope of the present disclosure.

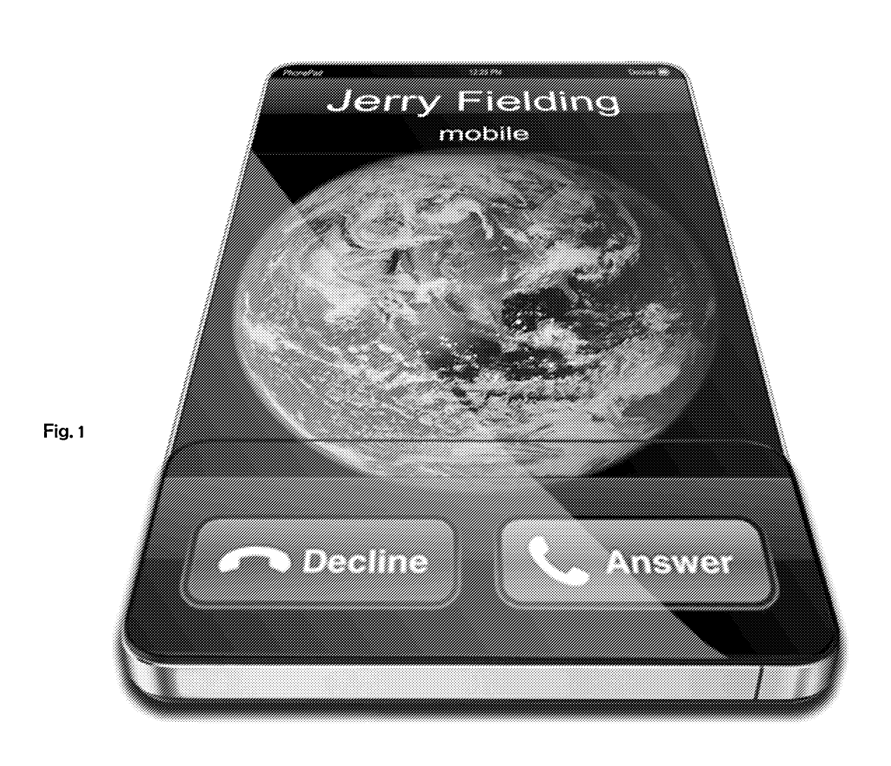

With general reference to FIGS. 1-13 of the drawings, various systems for docking a mobile telephone to a personal electronic device in accordance with the present teachings are illustrated. Throughout the views, the various systems are shown to include a substantially identical mobile telephone. The mobile telephones illustrated throughout the various views may differ for purposes of electronically coupling to the respective personal electronic device. It will be understood that the mobile telephone shown throughout the drawings is merely exemplary and that other mobile telephones may be alternatively incorporated within the scope of the present teachings. To the extent not otherwise described herein, the mobile telephones shown throughout the drawings will be understood to be conventional in both construction and operation and further understood to be substantially identical throughout the drawings.

Turning particularly to FIG. 1, a first system for docking a mobile telephone to a personal electronic device in accordance with the present teachings is illustrated. The mobile telephone may include a display or screen. The display may be touch responsive and may extend for substantially an entire front face of the mobile telephone. The mobile telephone has a length that is greater than a width. The display may alternatively operate in a landscape mode (in which the length of the mobile telephone is parallel to a top and bottom) and a portrait mode (in which the length of the mobile telephone is perpendicular to a top and bottom). The display may conventionally toggle between the landscape and portrait modes in response to the orientation of the mobile telephone. As illustrated, the mobile telephone has rounded corners when viewed from the front.

The mobile telephone is equipped with conventionally technology that allows the user to perform various electronic tasks. For example, the mobile telephone may allow the user to send and receive email communications, edit and save documents, store and play music files, store and display picture files, maintain calendar dates, access the internet, among other task. Such mobile telephones are often referred to as “smart phones”.

The personal electronic device shown in FIG. 1 is a computer tablet. To the extent not otherwise described herein, it will be understood that the computer tablet is conventional in both operation and construction. It will be further understood that the computer tablet shown in various views herein are substantially identical to the extent not otherwise described. As with the mobile telephone, the computer tablet may include a display or screen. The display of the computer tablet may be touch responsive and may extend for substantially an entire front face of the computer tablet. The computer tablet has a length that is greater than a width. As illustrated, the width of the computer tablet is substantially identical to the length of the mobile telephone.

The display may alternatively operate in a landscape mode (in which the length of the computer tablet is parallel to a top and bottom) and a portrait mode (in which the length of the computer tablet is perpendicular to a top and bottom). The display of the computer tablet may conventionally toggle between the landscape and portrait modes in response to the orientation of the computer tablet.

The mobile telephone may be electronically coupled to the computer tablet for the exchange of data (i.e., synching), for charging of the mobile telephone, and for display sharing (as will be discussed herein). In the embodiment illustrated, the computer tablet may particularly configured to cooperate with the mobile telephone. For example, a lower edge of the computer tablet may be configured to matingly receive a length of the mobile telephone. The computer tablet may define concave surfaces that cooperatively receive two of the rounded corners of the mobile telephone.

When the mobile telephone is coupled to the computer tablet, as shown in FIG. 1, the resulting device has a front face with an increased area. The width of the resulting device is equivalent to the length of the mobile telephone. The length of the resulting device has a length equal to the sum of the length of the computer tablet and width of the mobile telephone. The front face of the resulting device defines a touch responsive display that substantially extends across the entire area of the front face of the resulting device.

When the mobile telephone is coupled to the computer tablet, as shown in FIG. 1, the electronics of both the mobile telephone and the computer tablet recognize the other device and adjust the image displayed on the cooperatively defined touch responsive display accordingly. In one application, the image displayed is dictated by the mobile telephone. In this regard, the image displayed on the cooperatively defined touch responsive display is the same image that would otherwise be displayed on the mobile telephone when the mobile telephone is not attached to the computer table. As illustrated in FIG. 1, the mobile telephone is in a phone mode.

When the mobile telephone is coupled to the computer tablet, as shown in FIG. 1, the image displayed on the cooperatively defined touch responsive display is automatically in a portrait mode relative to the length and width of the collective device. Alternatively, the image may be alternatively displayed in either landscape mode or portrait mode depending on the orientation of the collective device. The display mode (portrait or landscape) is automatically controlled by software resident on the mobile telephone, the computer tablet or both.

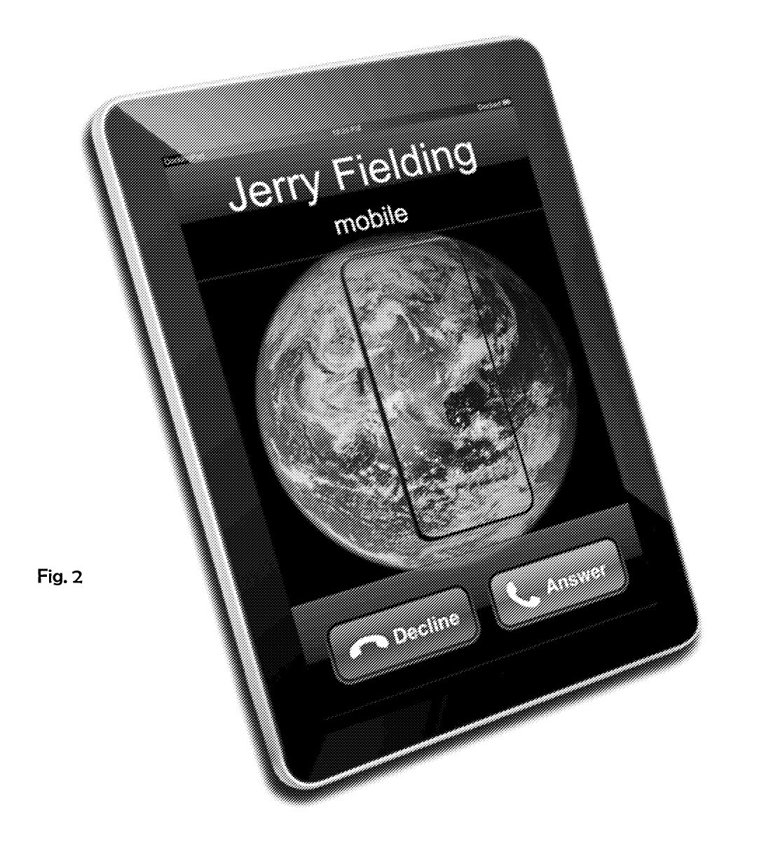

Turning to FIG. 2, another system for docking a mobile telephone to a personal electronic device in accordance with the present teachings is illustrated. As with the system of FIG. 1, the personal electronic device is a computer tablet. The system of FIG. 2 differs from the system of FIG. 1 in that the computer tablet defines an opening spaced from all its edges that is sized and shaped to receive the mobile telephone. Otherwise, it will be understood that the system of FIG. 2 is substantially identical in construction and operation to the system of FIG. 1.

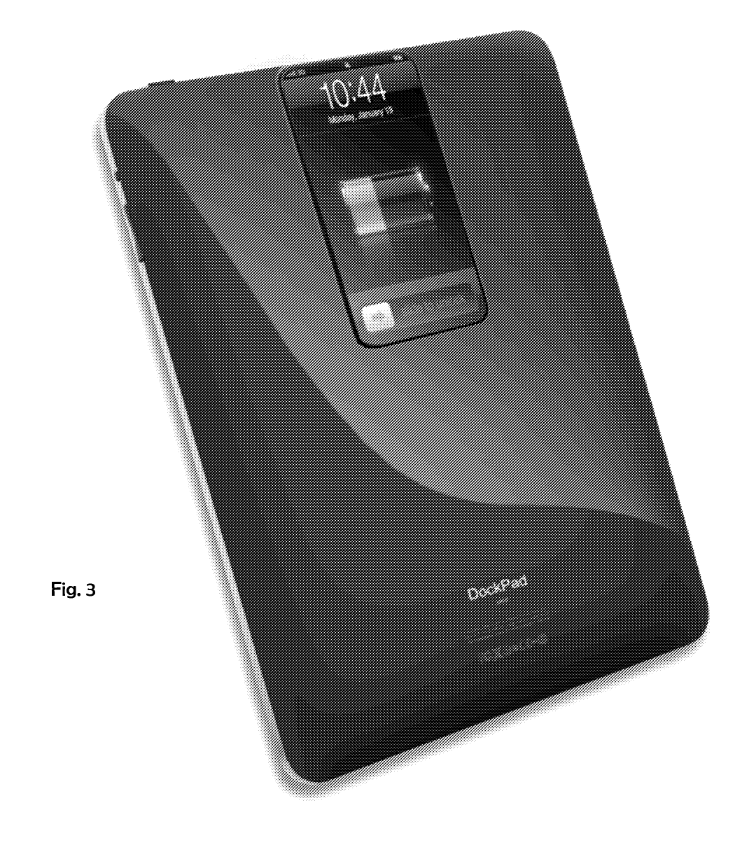

Turning to FIG. 3, another system for docking a mobile telephone to a personal electronic device in accordance with the present teachings is illustrated. As with the systems of FIGS. 1 and 2, the personal electronic device is a computer tablet. In this embodiment, the computer tablet defines an opening on a rear side for receiving the mobile telephone. The mobile telephone may be coupled to the computer tablet for both charging and data exchange. The mobile telephone remains completely operative when coupled to the computer tablet.

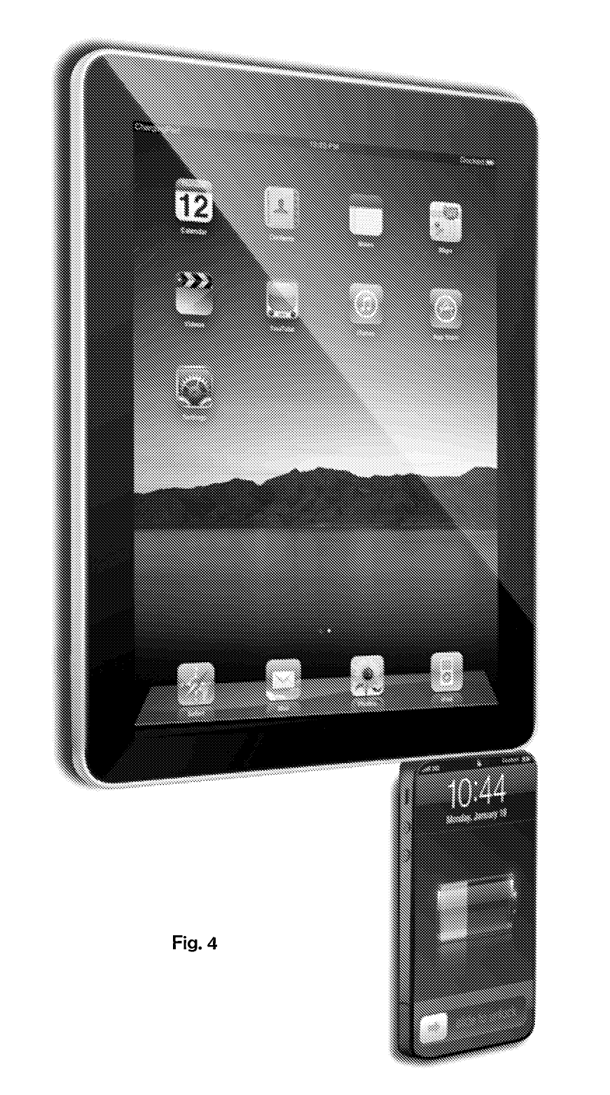

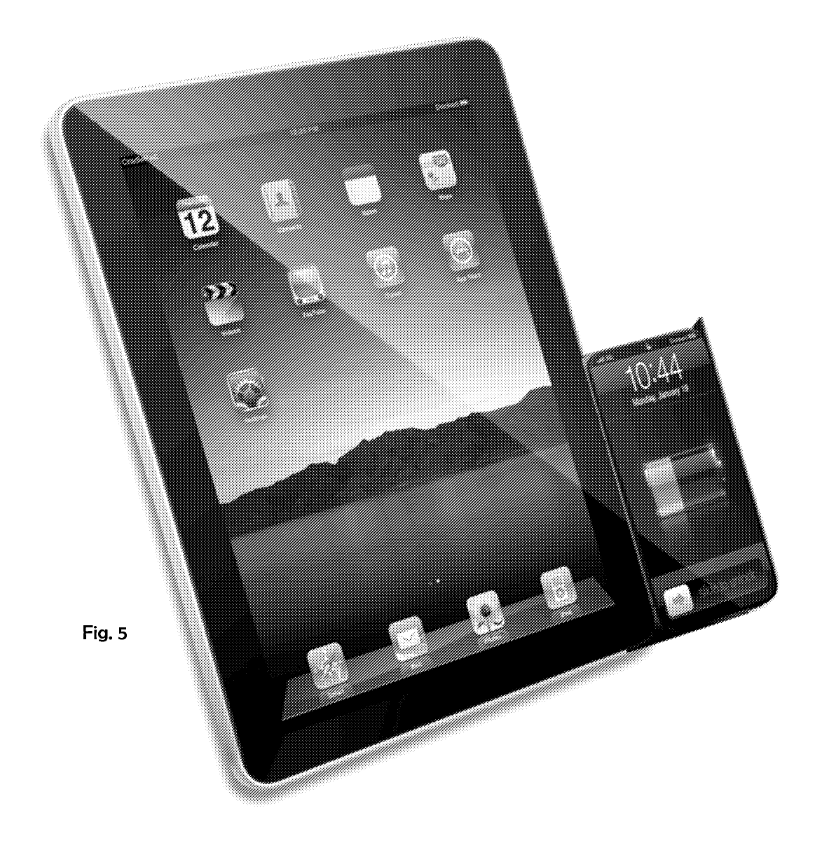

Turning to FIGS. 4 and 5, two further systems for docking a mobile telephone to a personal electronic device in accordance with the present teachings are illustrated. As with the systems of FIGS. 1 through 3, the personal electronic device is a computer tablet. In these embodiments, the mobile telephone is coupled to the computer tablet along one of the sides of the computer tablet. Upon coupling, the mobile telephone may be both charged and data may be exchanged between the mobile telephone and the computer tablet. In both embodiments, the mobile telephone remains completely operative when coupled to the computer tablet.

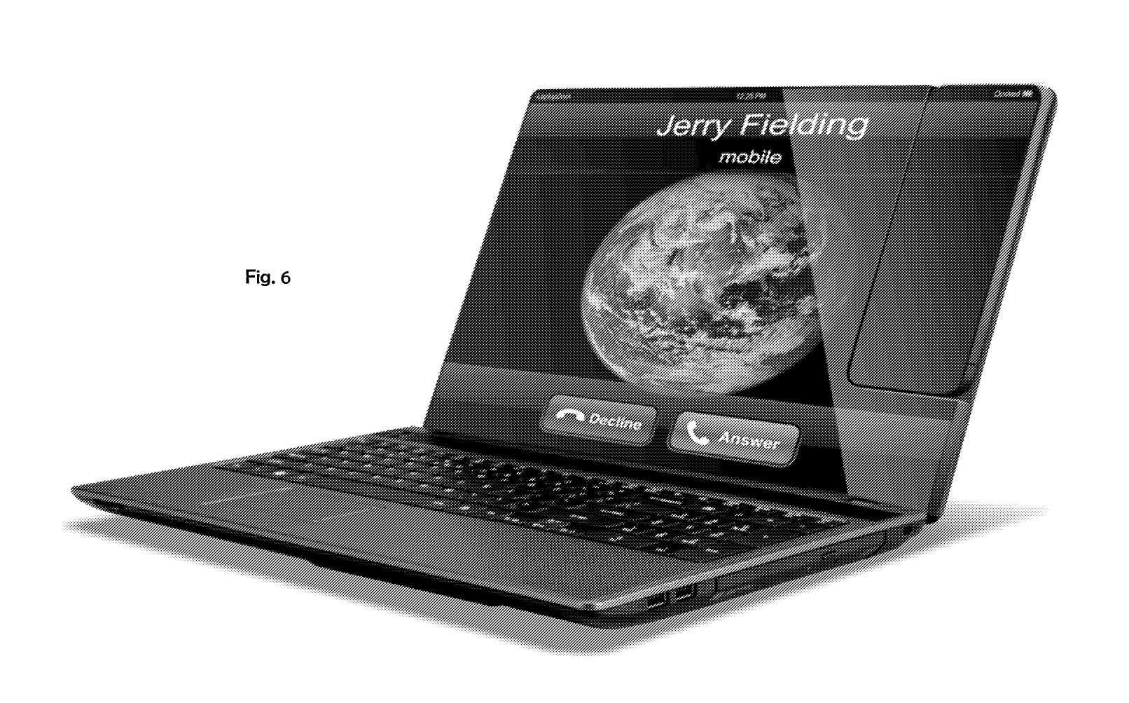

Turning to FIG. 6, another system for docking a mobile telephone to a personal electronic device in accordance with the present teachings is illustrated. In this system, the personal electronic device is a laptop computer. To the extent not otherwise described herein, it will be understood that the laptop computer is conventional in both operation and construction. It will be further understood that the laptop computer shown in various views herein are substantially identical to the extent not otherwise described. As with the mobile telephone, the laptop computer may include a display or screen. The display of the laptop computer may extend for substantially an entire front face of the laptop computer. The computer tablet has a length that is greater than a width.

The mobile telephone may be electronically coupled to the laptop computer for the exchange of data (i.e., synching), for charging of the mobile telephone, and for display sharing (as will be discussed herein). In the embodiment illustrated, the laptop computer may be particularly configured to cooperate with the mobile telephone. For example, laptop computer may define an opening configured to matingly receive the mobile telephone. The laptop computer may define one or more concave surfaces that cooperatively receive one or more of the rounded corners of the mobile telephone.

When the mobile telephone is coupled to the laptop computer, as shown in FIG. 6, the resulting device has a front face with an increased area. The front face of the resulting device defines a display that substantially extends across the entire area of the front face of the resulting device.

When the mobile telephone is coupled to the laptop computer, as shown in FIG. 6, the electronics of both the mobile telephone and the laptop computer recognize the other device and adjust the image displayed on the cooperatively defined display accordingly. In one application, the image displayed is dictated by the mobile telephone. In this regard, the image displayed on the cooperatively defined display is the same image that would otherwise be displayed on the mobile telephone when the mobile telephone is not attached to the computer table. As illustrated in FIG. 6, the mobile telephone is in a phone mode.

When the mobile telephone is coupled to the computer tablet, as shown in FIG. 6, the image displayed on the cooperatively defined display is automatically in a landscape mode relative to the length and width of the collective device. Alternatively, the image may be alternatively displayed in either landscape mode or portrait mode depending on the orientation of the collective device. The display mode (portrait or landscape) is automatically controlled by software resident on the mobile telephone, the computer tablet or both.

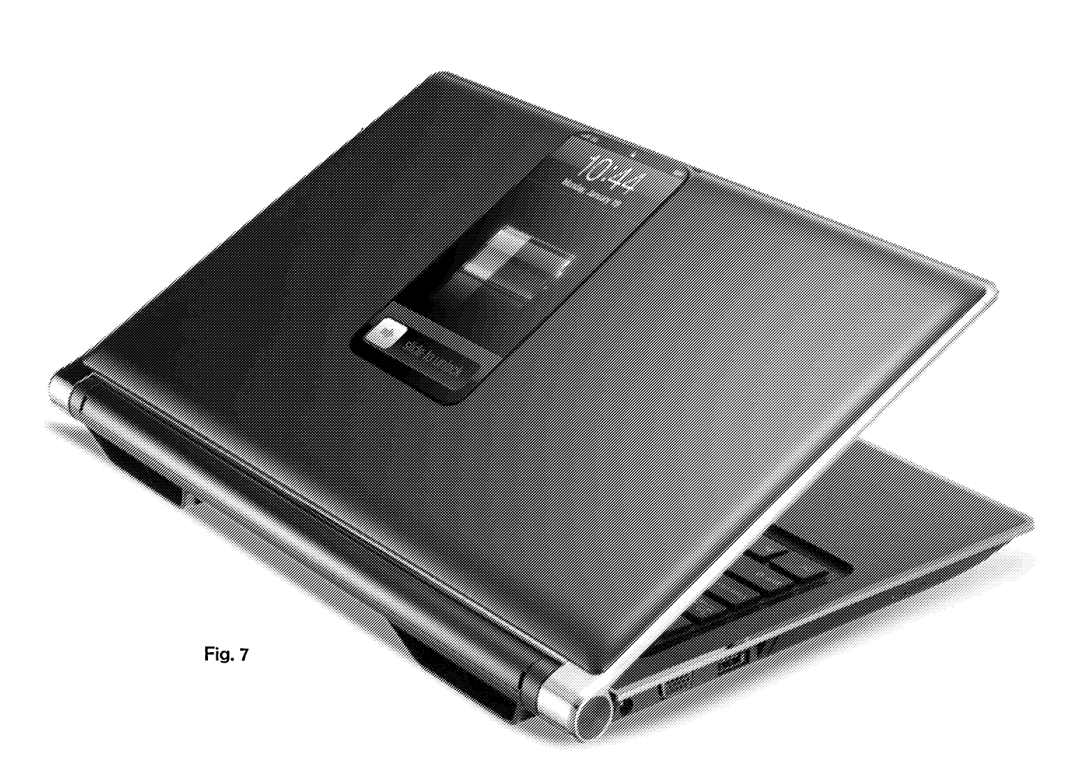

Turning to FIG. 7, another system for docking a mobile telephone to a personal electronic device in accordance with the present teachings is illustrated. As with the system of FIG. 6, the personal electronic device is a laptop computer. In this embodiment, the laptop computer defines an opening on a rear side for receiving the mobile telephone. The mobile telephone may be coupled to the laptop computer for both charging and data exchange. The mobile telephone remains completely operative when coupled to the laptop computer.

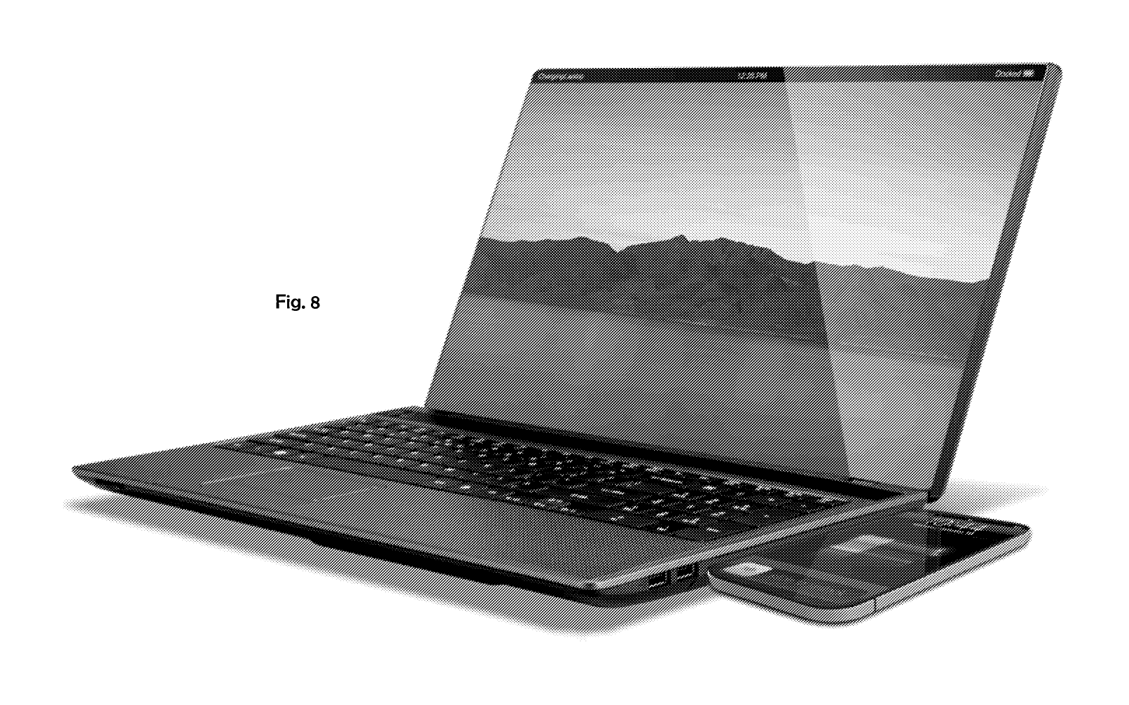

Turning to FIG. 8, another system for docking a mobile telephone to a personal electronic device in accordance with the present teachings is illustrated. As with the systems of FIGS. 6 and 7, the personal electronic device is a laptop computer. In this embodiment, the mobile telephone is coupled to the laptop computer along one of the sides of the laptop computer. Upon coupling, the mobile telephone may be both charged and data may be exchanged between the mobile telephone and the laptop computer. The mobile telephone remains completely operative when coupled to the laptop computer.

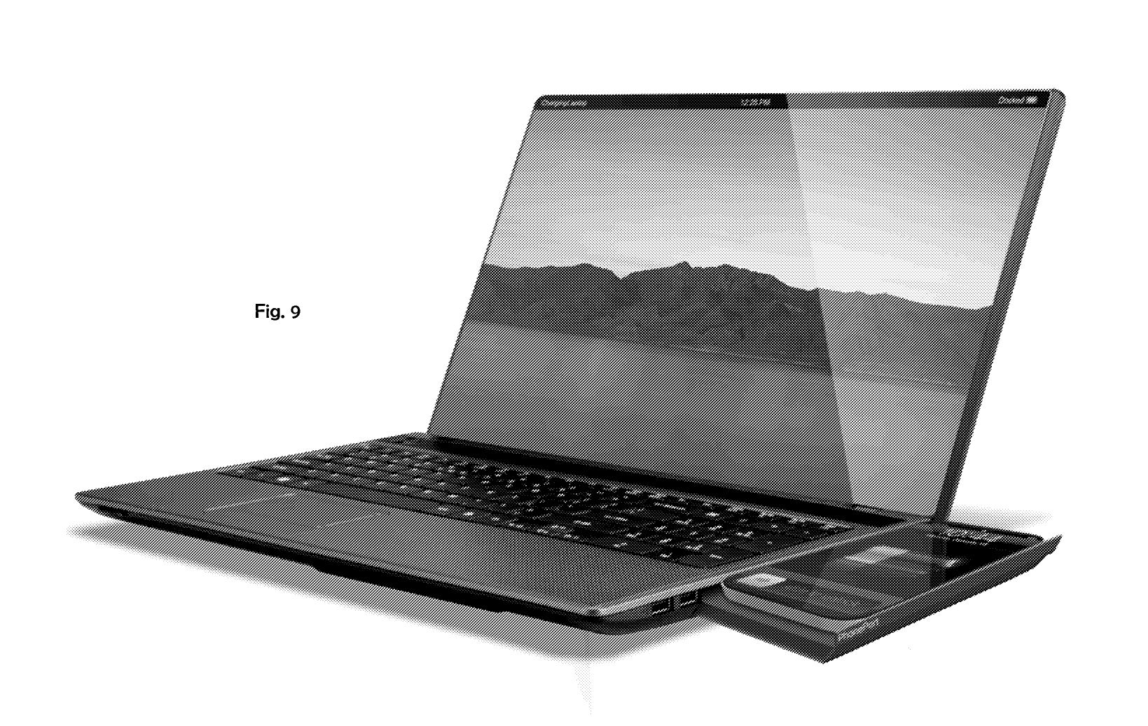

Turning to FIG. 9, another system for docking a mobile telephone to a personal electronic device in accordance with the present teachings is illustrated. In this system, the personal electronic device is again a laptop computer. The system of FIG. 9 is similar to the system of FIG. 8 but additionally incorporates a docking port for the mobile telephone. The mobile telephone may electrically couple to the laptop computer through the docking port. Alternatively, the docking port may engage the housing of the laptop computer for purposes of physically supporting the mobile telephone and the mobile telephone may directly couple electronically to the laptop computer. To the extent not otherwise described herein, it will be understood that the system of FIG. 9 is identical to the system of FIG. 8.

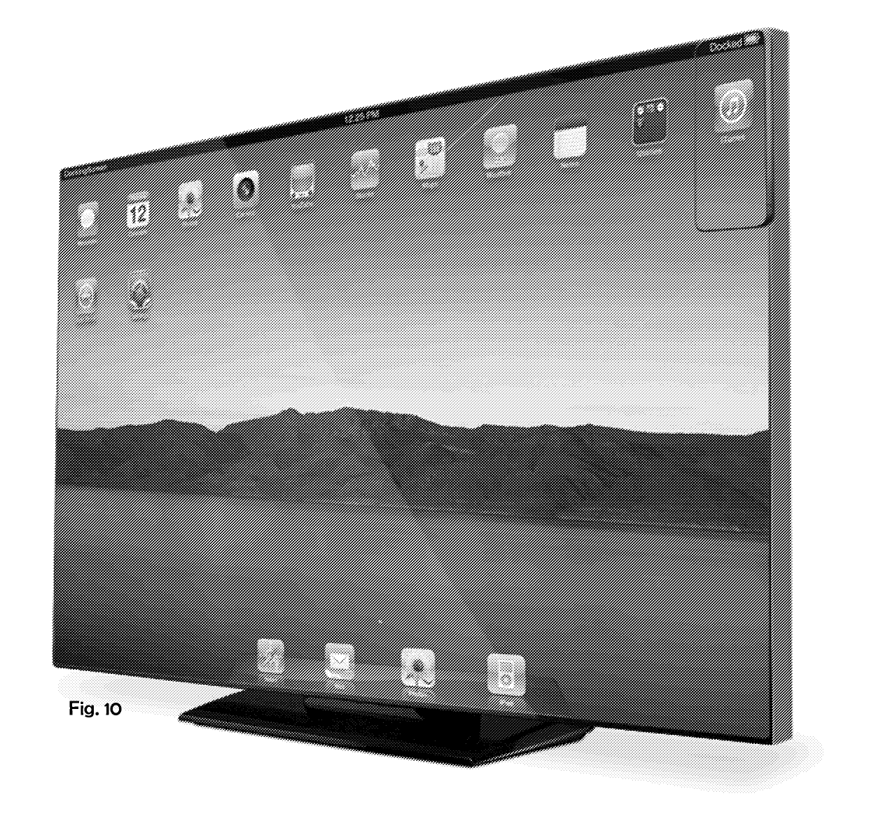

Turning to FIG. 10, another system for docking a mobile telephone to a personal electronic device in accordance with the present teachings is illustrated. In this system, the personal electronic device is a television. To the extent not otherwise described herein, it will be understood that the television is conventional in both operation and construction. It will be further understood that the television shown in various views herein are substantially identical to the extent not otherwise described. As with the mobile telephone, the television may include a display or screen. The display of the television may extend for substantially an entire front face of the television. The television has a length that is greater than a width.

The mobile telephone may be electronically coupled to the television for the exchange of data (i.e., synching), for charging of the mobile telephone, and for display sharing (as will be discussed herein). In the embodiment illustrated, the television may be particularly configured to cooperate with the mobile telephone. For example, television may define an opening configured to matingly receive the mobile telephone. The television may define one or more concave surfaces that cooperatively receive one or more of the rounded corners of the mobile telephone.

When the mobile telephone is coupled to the television, as shown in FIG. 10, the resulting device has a front face with an increased area. The front face of the resulting device defines a display that substantially extends across the entire area of the front face of the resulting device.

When the mobile telephone is coupled to the television, as shown in FIG. 10, the electronics of both the mobile telephone and the television recognize the other device and adjust the image displayed on the cooperatively defined display accordingly. In one application, the image displayed is dictated by the mobile telephone. In this regard, the image displayed on the cooperatively defined display is the same image that would otherwise be displayed on the mobile telephone when the mobile telephone is not attached to the computer table. As illustrated in FIG. 10, the mobile telephone is in a phone mode.

When the mobile telephone is coupled to the television, as shown in FIG. 10, the image displayed on the cooperatively defined display is automatically in a landscape mode relative to the length and width of the collective device. The display mode (e.g., landscape) is automatically controlled by software resident on the mobile telephone, the television or both.

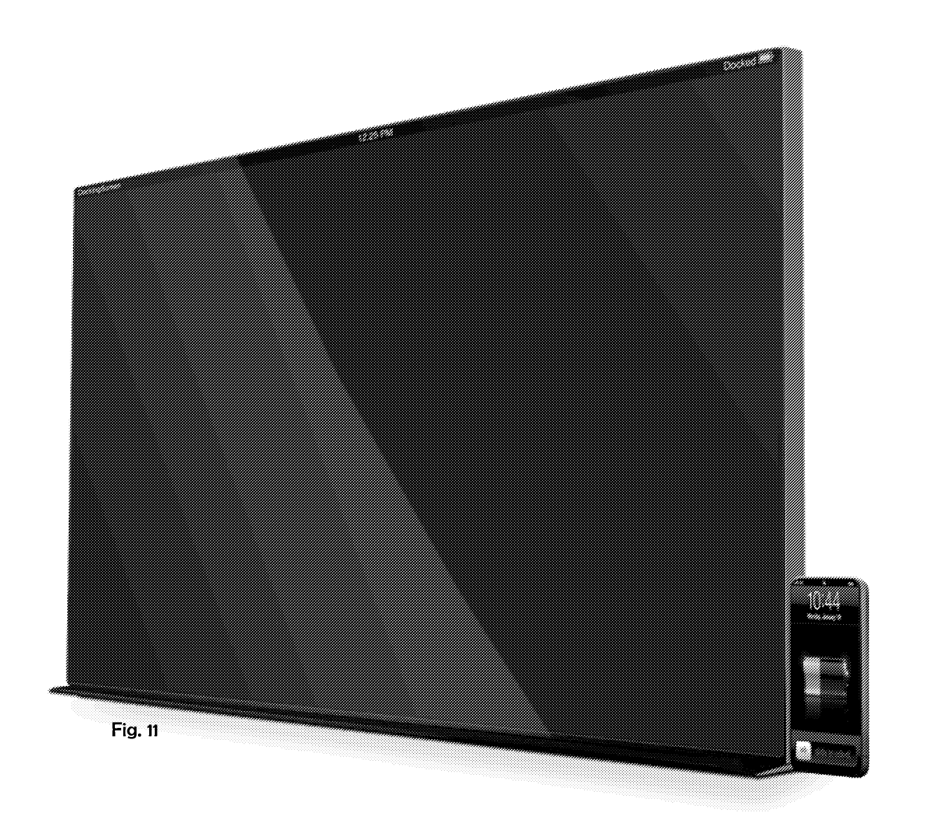

Turning to FIG. 11, another system for docking a mobile telephone to a personal electronic device in accordance with the present teachings is illustrated. As with the system of FIG. 10, the personal electronic device is a television. In this embodiment, the mobile telephone is coupled to the television along one of the sides of the television. Upon coupling, the mobile telephone may be both charged and data may be exchanged between the mobile telephone and the television. The mobile telephone remains completely operative when coupled to the television.

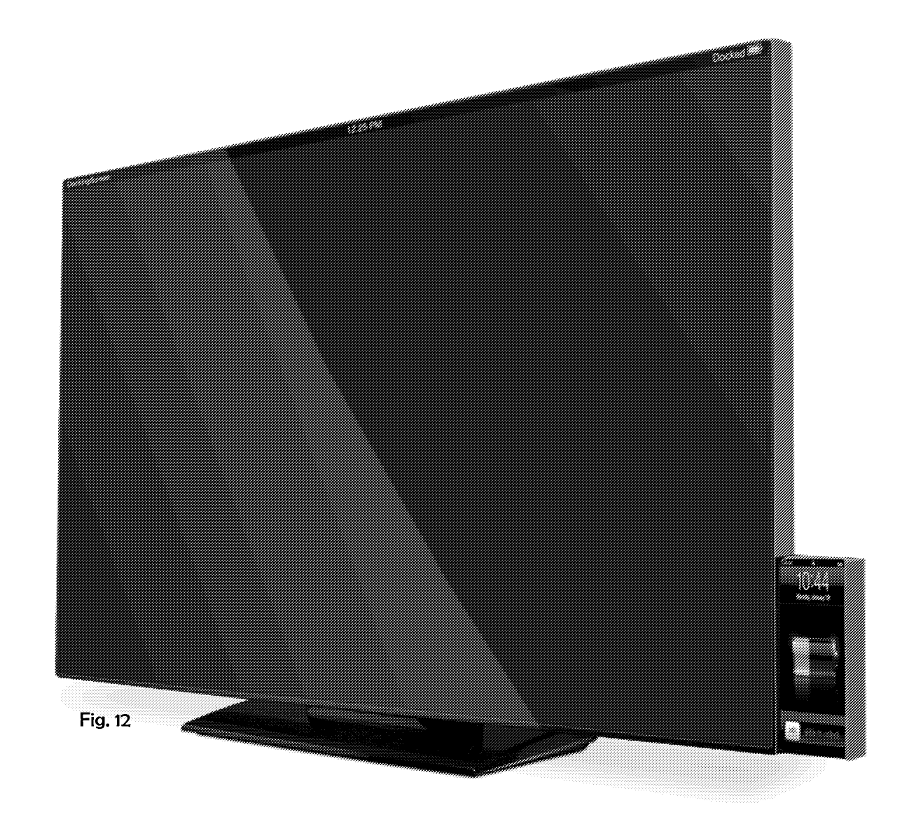

Turning to FIG. 12, another system for docking a mobile telephone to a personal electronic device in accordance with the present teachings is illustrated. In this system, the personal electronic device is again a television. The system of FIG. 12 is similar to the system of FIG. 10 but additionally incorporates a docking port for the mobile telephone. The mobile telephone may electrically couple to the television through the docking port. Alternatively, the docking port may engage the housing of the television for purposes of physically supporting the mobile telephone and the mobile telephone may directly couple electronically to the television. To the extent not otherwise described herein, it will be understood that the system of FIG. 12 is identical to the system of FIG. 11.

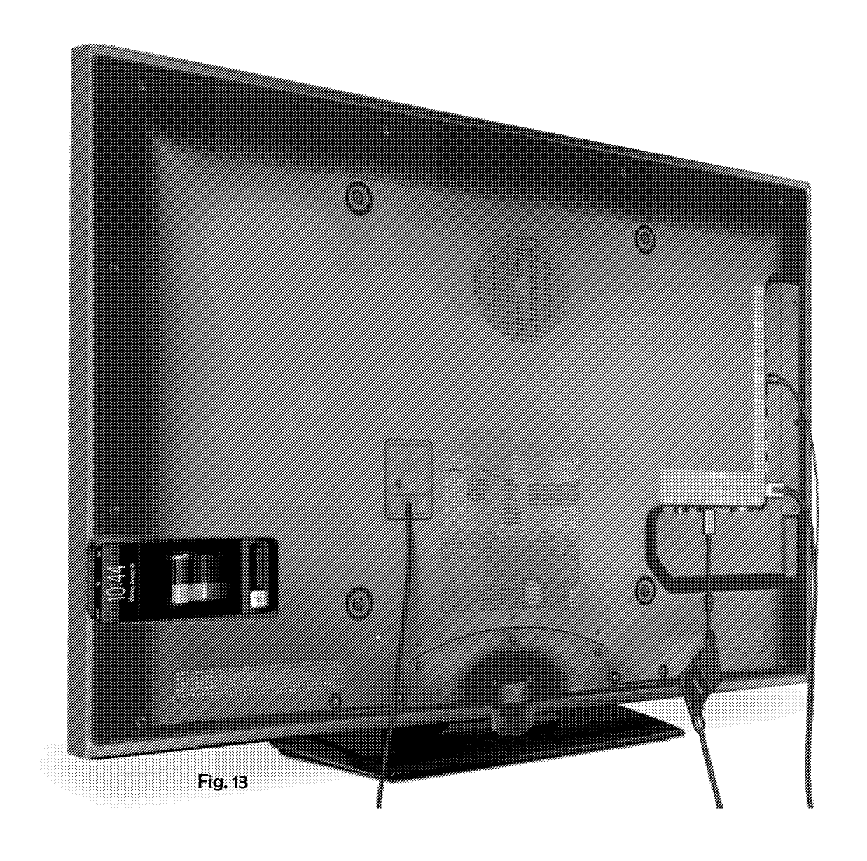

Turning to FIG. 13, another system for docking a mobile telephone to a personal electronic device in accordance with the present teachings is illustrated. As with the systems of FIGS. 10 through 12, the personal electronic device is a television. In this embodiment, the television defines an opening on a rear side for receiving the mobile telephone. The mobile telephone may be coupled to the television for both charging and data exchange. The mobile telephone remains completely operative when coupled to the television.

While specific examples have been described in the specification and illustrated in the drawings, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

What is claimed is:

1. A system for docking a mobile telephone to a personal electronic device, the system comprises:
a mobile telephone including a first front face defining a first display with a first display area; and
a personal electronic device including a second front face defining a second display with a second display area, the second front face defining an opening for receiving the mobile telephone;
whereby the mobile telephone and the personal electronic device cooperate to define a resulting device having a resulting display having a resulting display area equal to the sum of the first and second display areas.

2. The system for docking a mobile telephone to a personal electronic device of claim 1, wherein the mobile telephone is a smart phone.

3. The system for docking a mobile telephone to a personal electronic device of claim 1, wherein the personal electronic device is a computer tablet.

4. The system for docking a mobile telephone to a personal electronic device of claim 1, wherein the personal electronic device is a laptop computer.

5. The system for docking a mobile telephone to a personal electronic device of claim 1, wherein the personal electronic device is a television.

6. The system for docking a mobile telephone to a personal electronic device of claim 1, wherein the mobile telephone is operative to exchange data with the personal electronic device and operative to charge when coupled to the personal electronic device.

7. The system for docking a mobile telephone to a personal electronic device of claim 1, further comprising software operative to automatically orient an image on the resulting device when the mobile telephone is electronically connected to the personal electronic device.

8. The system for docking a mobile telephone to a personal electronic device of claim 7, wherein the software is resident on the mobile telephone, the personal electronic device or a combination thereof.

9. The system for docking a mobile telephone to a personal electronic device of claim 7, wherein the software automatically orients the image on the collective device to a landscape mode.

10. The system for docking a mobile telephone to a personal electronic device of claim 7, wherein the display of the collective device is touch responsive.

11. The system for docking a mobile telephone to a personal electronic device of claim 7, wherein the first display has a first length and a first width, the second display has a second length and a second width and the collective display has a collective width equal to the first length and a collective length equal to a sum of the second length and the first width.

12. The system for docking a mobile telephone to a personal electronic device of claim 1, wherein an image displayed by the collective device is controlled by the mobile telephone.
